(19) United States
(12) Patent Application Publication
(10) Pub. No.: US 2025/0224948 A1
(43) Pub. Date: Jul. 10, 2025

(54) Firmware code development method

(71) Applicant: MELLANOX TECHNOLOGIES, LTD., Yokneam (IL)

(72) Inventor: Ido Zemah, Tel Aviv (IL)

(21) Appl. No.: 18/406,261

(22) Filed: Jan. 8, 2024

(51) Int. Cl. G06F 8/65; G06F 8/41; G06F 8/71

(52) U.S. Cl. CPC G06F 8/65; G06F 8/447; G06F 8/71

(57) ABSTRACT

In one embodiment, a computing device includes a data interface to connect to and share data with configuration space registers of a silicon chip via an external physical interface of the silicon chip, a processing unit to execute a procedure to update parts of firmware source code configured to access the configuration space registers from a firmware processor embedded on the silicon chip via an internal physical interface of the silicon chip to access the configuration space registers via the data interface and via the external physical interface of the silicon chip, yielding modified firmware source code, and execute a software compiler to compile the modified firmware source code yielding compiled software.

### FIELD OF THE INVENTION

The present invention relates to silicon chips, and in particular, but not exclusively to, firmware development for silicon chips.

### BACKGROUND

A silicon chip may include an embedded firmware processor, e.g., a reduced instruction set computer (RISC) processor, for executing firmware. Firmware source code may be written in a suitable development environment and compiled for running on the embedded firmware processor. The compiled firmware may be burnt on to a memory, such as a flash memory, and then the silicon chip is powered up causing the compiled firmware code to be loaded through an interface (e.g., SPI interface) into internal memory of the silicon chip. The embedded firmware processor then fetches commands of the loaded compiled firmware code and executes the commands (e.g., one by one). The compiled firmware may then be tested as the firmware runs on the silicon chip. Based on the tests, the firmware source code may then be updated in the development environment, recompiled, burnt again onto memory, loaded into the internal memory of the silicon chip by powering down and powering up the silicon chip, and so on. The amended compiled firmware code is then executed, tested, and based on the tests the firmware source code may then be updated again in the development environment, recompiled, burnt again onto memory, loaded into the internal memory of the silicon chip by powering down and powering up the silicon chip, and so on.

### SUMMARY

There is provided in accordance with an embodiment of the present disclosure, a system, including a computing device, including a data interface to connect to and share data with configuration space registers of a silicon chip via an external physical interface of the silicon chip, and a processing unit to execute a procedure to update parts of firmware source code configured to access the configuration space registers from a firmware processor embedded on the silicon chip via an internal physical interface of the silicon chip to access the configuration space registers via the data interface and via the external physical interface of the silicon chip, yielding modified firmware source code, and execute a software compiler to compile the modified firmware source code yielding compiled software.

Further in accordance with an embodiment of the present disclosure the processing unit is to execute the compiled software to cause the data interface to read from, and write to, the configuration space registers of the silicon chip via the external physical interface of the silicon chip.

Still further in accordance with an embodiment of the present disclosure the processing unit is to execute the compiled software to perform computations based on the configuration space registers.

Additionally in accordance with an embodiment of the present disclosure, the system includes the silicon chip, which includes hardware logic to operate based on data stored in the configuration space registers, and the embedded firmware processor.

Moreover, in accordance with an embodiment of the present disclosure the processing unit is to execute a firmware compiler to compile the firmware source code to yield compiled firmware, and the embedded firmware processor of the silicon chip is to execute the compiled firmware.

Further in accordance with an embodiment of the present disclosure the processing unit is to write the compiled firmware on a memory, and the embedded firmware processor is to load the compiled firmware from the memory.

Still further in accordance with an embodiment of the present disclosure the compiled firmware is to cause the embedded firmware processor to read from, and write to, the configuration space registers of the silicon chip via the internal physical interface of the silicon chip, and cause the embedded firmware processor to perform computations based on data stored in the configuration space registers.

Additionally in accordance with an embodiment of the present disclosure the processing unit is to execute the procedure to update parts of a new version of the firmware source code configured to access the configuration space registers from the embedded firmware processor via the internal physical interface to access the configuration space registers via the data interface and via the external physical interface of the silicon chip, yielding a modified version of the new version of the firmware source code, execute the software compiler to compile the modified version of the new version of the firmware source code yielding newly compiled software, and execute the newly compiled software to cause the data interface to read from, and write to, the configuration space registers of the silicon chip via the external physical interface of the silicon chip.

Moreover, in accordance with an embodiment of the present disclosure the processing unit is to run at least one debug method of the compiled software, and receive a correction to the firmware source code yielding the new version of the firmware source code.

Further in accordance with an embodiment of the present disclosure the processing unit is to execute the compiled software to cause the data interface to read from, and write to, other configuration space registers of another silicon chip, which does not have an embedded firmware processor, via an external physical interface of the other silicon chip.

There is also provided in accordance with another embodiment of the present disclosure, a computing method, including connecting to and sharing data with configuration space registers of a silicon chip via an external physical interface of the silicon chip, executing a procedure to update parts of firmware source code configured to access the configuration space registers from a firmware processor embedded on the silicon chip via an internal physical interface of the silicon chip to access the configuration space registers via the external physical interface of the silicon chip, yielding modified firmware source code, and executing a software compiler to compile the modified firmware source code yielding compiled software.

Still further in accordance with an embodiment of the present disclosure, the method includes executing the compiled software to cause a data interface to read from, and write to, the configuration space registers of the silicon chip via the external physical interface of the silicon chip.

Additionally in accordance with an embodiment of the present disclosure, the method includes executing the compiled software to perform computations based on the configuration space registers.

Moreover, in accordance with an embodiment of the present disclosure, the method includes hardware logic of the silicon chip operating based on data stored in the configuration space registers.

Further in accordance with an embodiment of the present disclosure, the method includes executing a firmware compiler to compile the firmware source code to yield compiled firmware, and executing the compiled firmware by the embedded firmware processor of the silicon chip.

Still further in accordance with an embodiment of the present disclosure, the method includes writing the compiled firmware on a memory, and loading the compiled firmware from the memory by the embedded firmware processor.

Additionally in accordance with an embodiment of the present disclosure, the method includes the compiled firmware causing the embedded firmware processor to read from, and write to, the configuration space registers of the silicon chip via the internal physical interface of the silicon chip, and the compiled firmware causing the embedded firmware processor to perform computations based on data stored in the configuration space registers.

Moreover in accordance with an embodiment of the present disclosure, the method includes executing the procedure to update parts of a new version of the firmware source code configured to access the configuration space registers from the embedded firmware processor via the internal physical interface to access the configuration space registers via external physical interface of the silicon chip, yielding a modified version of the new version of the firmware source code, executing the software compiler to compile the modified version of the new version of the firmware source code yielding newly compiled software, and executing the newly compiled software to cause the data interface to read from, and write to, the configuration space registers of the silicon chip via the external physical interface of the silicon chip.

Further in accordance with an embodiment of the present disclosure, the method includes running at least one debug method of the compiled software, and receiving a correction to the firmware source code yielding the new version of the firmware source code.

Still further in accordance with an embodiment of the present disclosure, the method includes executing the compiled software to cause a data interface to read from, and write to, other configuration space registers of another silicon chip, which does not have an embedded firmware processor, via an external physical interface of the other silicon chip.

### BRIEF DESCRIPTION OF THE DRAWINGS

The present invention will be understood from the following detailed description, taken in conjunction with the drawings in which:

FIG. 1 is a block diagram view of a firmware development system constructed and operative in accordance with an embodiment of the present invention;

FIG. 2 is a flowchart including steps in a method of developing firmware in the system of FIG. 1;

FIG. 3 is a flowchart including steps in a method of loading and executing firmware in the system of FIG. 1; and

FIG. 4 is a block diagram view of a firmware development system constructed and operative in accordance with an alternative embodiment of the present invention.

### DESCRIPTION OF EXAMPLE EMBODIMENTS

### Overview

As previously mentioned, the compiled firmware may be tested as the firmware runs on a silicon chip. Based on the tests (e.g., based on finding one or more bugs), the firmware source code may then be updated in the development environment, recompiled, burnt again onto memory, loaded into the internal memory of the silicon chip by powering down and powering up the silicon chip, and so on. The amended compiled software code is then executed, tested, and based on the tests the firmware source code may then be updated again in the development environment, recompiled, burnt again onto memory, loaded into the internal memory of the silicon chip by powering down and powering up the silicon chip, and so on. The above process is very time-consuming and inefficient.

Embodiments of the present invention address at least some of the above drawbacks by providing an efficient firmware development system and method which allows firmware development including rounds of testing and amending the firmware source code without having to burn the firmware on to memory and without having to restart the silicon chip. The firmware is coded by the developer as it would normally be coded for running on the embedded firmware processor. Instead of compiling the firmware source code for running by the embedded firmware processor, the firmware source code is suitably updated (described in more detail below) and compiled with a software compiler (e.g., an x86 compiler) to run on a processor such as a central processing unit (CPU). The compiled software while being executed on the CPU reads data from, and writes data to, configuration space registers of the silicon chip via an external physical interface of the silicon chip, for example, e.g., via an I²C interface. The compiled software performs computations based on the read data yielding other data which is written to the configuration space registers of the silicon chip via the external physical interface of the silicon chip. Hardware logic on the silicon chip also reads data from, and writes data to, the configuration space registers via an internal physical interface of the silicon chip and performs computations based on the read data yielding data which is written to the configuration space registers. In the above manner, the firmware running on the CPU as software causes the hardware logic to operate as if the firmware is running on the embedded firmware processor, and the firmware may be tested “on” the silicon chip without actually running the firmware on the silicon chip. During the testing, the firmware is run as software on the CPU and bugs may be identified and fixed in the development environment without having to run the firmware on the embedded firmware processor of the silicon chip. Once the firmware has completed testing, the firmware source code is compiled using a firmware compiler and is burnt onto memory for loading onto the silicon chip's internal memory for executing by the embedded firmware processor of the silicon chip.

As mentioned above, the system includes a procedure which when executed updates the firmware source code prior to being compiled by the software compiler. The procedure updates parts of the firmware source code configured to access the configuration space registers of the silicon chip from the firmware processor embedded on the silicon chip via the internal physical interface of the silicon chip to access the configuration space registers via the external physical interface of the silicon chip, yielding modified firmware source code. The modified firmware source code is then compiled using a software compiler for execution by the CPU, as described above. Therefore, the compiled software functions in substantially the same way as the firmware, except that the software is run on a processor (e.g., CPU) external to the silicon chip (and not on the embedded firmware processor), and the access mode to the configuration space registers is via the external physical interface of the silicon chip and not via the internal physical interface of the silicon chip.

In some embodiments, during development of the firmware source code, debug methods may be added to the firmware source code, and compiled to yield the software running on the CPU. The debug methods may be selectively enabled and disabled during testing of the “firmware” running on the CPU.

The above development system and method allows the firmware to be developed efficiently and quickly as the source code does not need to be written to memory and loaded on to the silicon chip with each revision of the firmware source code.

In some embodiments, once the firmware has completed testing and a final firmware version is available, the final firmware version is compiled yielding compiled firmware, which may be burnt on to a memory, such as a flash memory, for loading therefrom to the internal memory of the silicon chip. In other embodiments, the compiled final firmware version may be loaded via a suitable interface, e.g., via an I²C interface, directly onto the internal memory of the silicon chip.

In some embodiments, once the firmware has completed testing and a final firmware version is available, the firmware source code may be compiled as software and executed by a CPU external to a silicon chip, which does not include an embedded firmware processor in order to operate the silicon chip using the external “firmware” from the CPU via the external physical interface of the silicon chip. In this manner, a silicon chip without an embedded firmware processor may be controlled by “firmware” from the CPU.

### System Description

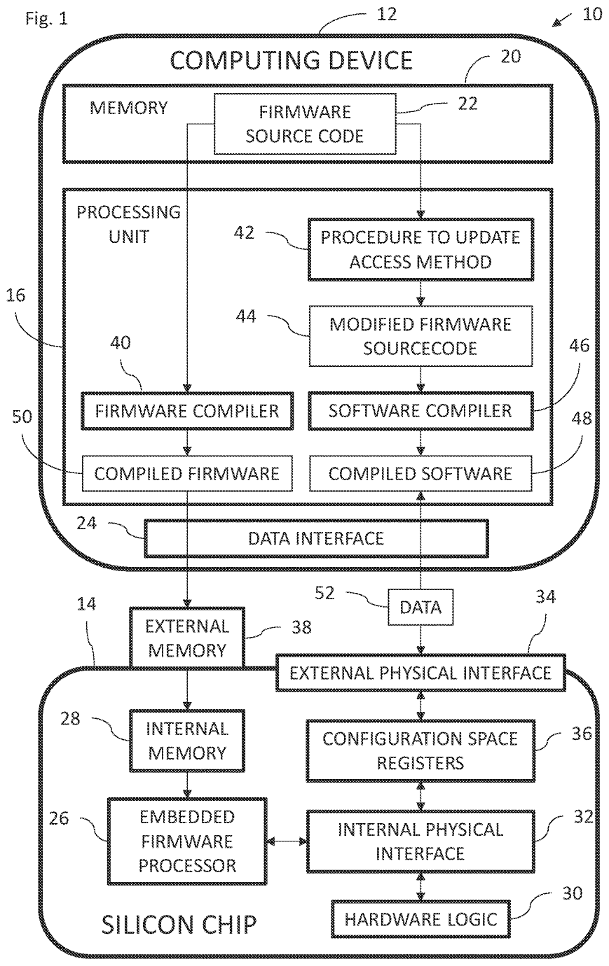

Reference is now made to FIG. 1, which is a block diagram view of a firmware development system 10 constructed and operative in accordance with an embodiment of the present invention. The system includes a computing device 12 and a silicon chip 14.

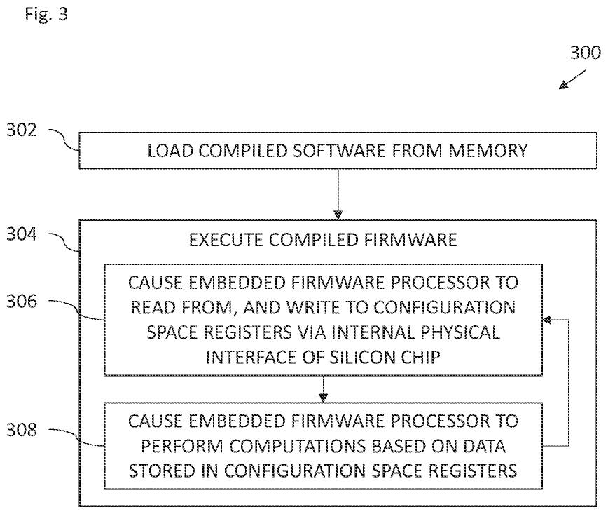

The silicon chip 14 includes an embedded firmware processor 26, an internal memory 28, hardware logic 30, an internal physical interface 32, an external physical interface 34, and configuration space registers 36. The system 10 may also include an external memory 38, such as a flash memory or any suitable memory, on which compiled firmware code 50 (once it has been sufficiently developed) may be burnt, as described in more detail with reference to FIG. 3. The external memory 38 is connected via an interface (e.g., Serial Peripheral Interface (SPI) interface) to the internal memory 28 of the silicon chip 14. Powering up the silicon chip 14 may result in compiled firmware code 50 being loaded from the external memory 38 to the internal memory 28, as described in more detail with reference to FIG. 3.

The embedded firmware processor 26 may include at least one reduced instruction set computer (RISC) processor. The embedded firmware processor 26 is configured to fetch commands of compiled firmware code 50 loaded on the internal memory 28, and execute the commands (e.g., one by one). The embedded firmware processor 26 is also configured to read data from, and write data to the configuration space registers 36 via the internal physical interface 32, as described in more detail with reference to FIG. 3. The hardware logic 30 is configured to read data from, and write data to, the configuration space registers 36 via the internal physical interface 32. The hardware logic 30 is configured to operate based on the data stored in the configuration space registers 36 yielding results which may be written to the configuration space registers 36. In the above manner, the hardware logic 30, and the firmware 50, which runs on the embedded firmware processor 26, interact with each other via the data in the configuration space registers 36. In practice, some or all of the functions of the embedded firmware processor 26 may be combined in a single physical component or, alternatively, implemented using multiple physical components. These physical components may comprise hard-wired or programmable devices, or a combination of the two.

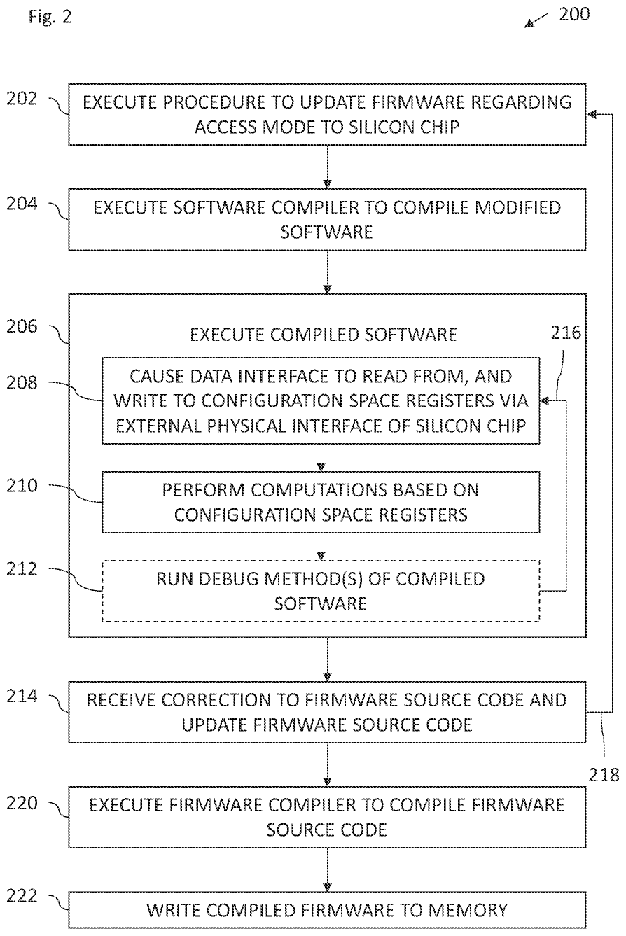

The computing device 12 may be any suitable computing device, for example, a personal computer, a laptop computer, or a tablet device. The computing device 12 includes a processing unit 16 such as a central processing unit (CPU). The computing device 12 also includes a memory 20 to store data, for example, firmware source code 22. The computing device 12 may also include a data interface 24, operative in accordance with any suitable data communication protocol, such as I²C protocol. The data interface 24 is configured to connect to, and share data 52 with, configuration space registers 36 of silicon chip 14 via external physical interface 34 of silicon chip 14, as described in more detail below and with reference to FIG. 2.

The processing unit 16 may be configured to execute a software code development program or editor (not shown) to enable a firmware developer to develop firmware source code 22 in any suitable programming language. The developer develops the firmware source code 22 based on the assumption that the firmware will be run on the embedded firmware processor 26 and access configuration space registers 36 via internal physical interface 32. The firmware developer may add debugging tools or methods to the firmware source code 22. The processing unit 16 may be configured to execute a firmware compiler 40 (e.g., once the firmware source code 22 is sufficiently developed) to compile the firmware source code 22 yielding compiled firmware 50. However, while the firmware source code 22 is still being developed, the firmware source code 22 is updated (as described in more detail below) and compiled as software which may be run by the processing unit 16 and access the configuration space registers 36 of silicon chip 14 via the external physical interface 34 to save many rounds of loading compiled firmware 50 on to the silicon chip 14 as previously described above in the overview section.

The processing unit 16 is configured to execute a procedure 42 to update an access method of the firmware source code 22 in which the firmware source code 22 accesses the configuration space registers 36. In particular, the procedure 42 changes the firmware source code 22 from accessing the configuration space registers 36 via the internal physical interface 32 to accessing the configuration space registers 36 via the external physical interface 34 yielding modified firmware source code 44, as described in more detail with reference to FIG. 2. The modified firmware source code 44 may be compiled using a software compiler 46 (e.g., an x86 compiler) yielding compiled software 48 for executing by the processing unit 16 (e.g., CPU) or any other suitable processor. The processing unit 16 is configured to execute the compiled software 48. The compiled software 48 accesses the configuration space registers 36 via data interface 24 and external physical interface 34 during execution of the compiled software 48 and functions substantially the same as the compiled firmware 50 would function if the compiled firmware 50 was loaded on to the silicon chip 14 and executed by embedded firmware processor 26 (except for the access method to configuration space registers 36, as described above).

In practice, some or all of the functions of the processing unit 16 may be combined in a single physical component or, alternatively, implemented using multiple physical components. These physical components may comprise hard-wired or programmable devices, or a combination of the two. In some embodiments, at least some of the functions of the processing unit 16 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 2, which is a flowchart 200 including steps in a method of developing firmware in the system 10 of FIG. 1. Reference is also made to FIG. 1. The processing unit 16 is configured to execute the procedure 42 to update parts of firmware source code 22 configured to access the configuration space registers 36 from firmware processor 26 embedded on silicon chip 14 via internal physical interface 32 of silicon chip 14 to access the configuration space registers 36 via the data interface 24 and via the external physical interface 34 of silicon chip 14, yielding modified firmware source code 44 (block 202). The processing unit 16 is configured to execute software compiler 46 to compile the modified firmware source code 44 yielding compiled software 48 (block 204).

The processing unit 16 is configured to execute the compiled software 48 (block 206) to cause the data interface 24 to read from, and write to, the configuration space registers 36 of silicon chip 14 via the external physical interface 34 of silicon chip 14 (block 208). The processing unit 16 is configured to: execute the compiled software 48 to perform computations based on the data read from the configuration space registers 36 yielding results (block 210); and write at least some of the results to configuration space registers 36. While the compiled software 48 is being executed by the processing unit 16, the hardware logic 30 of the silicon chip 14 is configured to read data from configuration space registers 36 via internal physical interface 32, perform computations based on the read data, and write results of the computations to configuration space registers 36 via internal physical interface 32. The processing unit 16 is configured to run at least one debug method of the compiled software 48 (for example, as enabled and disabled by the firmware developer) (block 212). The steps of blocks 208-212 may be performed in any suitable order and repeated (arrow 216) any suitable number of times.

Based on the testing of the compiled software 48 running on the processing unit 16 and interacting with the configuration space registers 36 of the silicon chip 14 via data interface 24 and external physical interface 34, the firmware developer may decide to make changes to the firmware source code 22 using the software code development program or editor. The processing unit 16 is configured to receive one or more corrections to the firmware source code 22 (from the firmware developer) yielding a new version of the firmware source code 22 (block 214).

The steps of blocks 202-214 may be repeated (arrow 218) any suitable number of times until the firmware source code 22 is developed and ready for loading on the silicon chip 14. For example, the processing unit 16 may be configured to execute the procedure 42 to update parts of a new version of the firmware source code 22 configured to access the configuration space registers 36 from the embedded firmware processor 26 via the internal physical interface 32 to access the configuration space registers 36 via the data interface 24 and via the external physical interface 34 of the silicon chip 14, yielding a modified version of the new version of the firmware source code 44 (block 202). The processing unit 16 may be configured to execute the software compiler 46 to compile the modified version of the new version of the firmware source code 44 yielding newly compiled software 48 (block 204). The processing unit 16 may be configured to execute the newly compiled software 48 (block 206) to cause the data interface 24 to read from, and write to, the configuration space registers 36 of the silicon chip 14 via the external physical interface 34 of the silicon chip 14 (block 208), perform computations based on the data of the configuration space registers 36 (block 210), and selectively run debug methods (block 212). Based on the further testing, the processing unit 16 may be configured to receive one or more further corrections to the firmware source code 22 (block 214), and so on.

Once the development of the firmware source code 22 is completed, the processing unit 16 is configured to execute firmware compiler 40 to compile the firmware source code 22 to yield compiled firmware 50 (block 220). In some embodiments, the processing unit 16 is configured to write the compiled firmware 50 on the external memory 38 (block 222). In other embodiments, the processing unit 16 is configured to write the compiled firmware 50 on the internal memory 28.

Reference is now made to FIG. 3, which is a flowchart 300 including steps in a method of loading and executing firmware in the system 10 of FIG. 1. Powering up the silicon chip 14 may result in the compiled firmware 50 being loaded from the external memory 38 to the internal memory 28. The embedded firmware processor 26 is configured to load the compiled firmware 50 (e.g., one command at a time) from the internal memory 28 (block 302). The embedded firmware processor 26 is configured to execute the compiled firmware 50 (block 304).

The compiled firmware 50 is configured to cause the embedded firmware processor 26 to read from, and write to, the configuration space registers 36 of the silicon chip 14 and internal physical interface 32 of the silicon chip 14 (block 306). The compiled firmware 50 is configured to cause the embedded firmware processor 26 to perform computations based on data stored in the configuration space registers 36 and write results from the computations to the configuration space registers 36 (block 308). While the compiled firmware 50 is being executed by the embedded firmware processor 26, the hardware logic 30 of the silicon chip 14 is configured to read data from configuration space registers 36 via internal physical interface 32, perform computations based on the read data, and write results of the computations to configuration space registers 36 via internal physical interface 32.

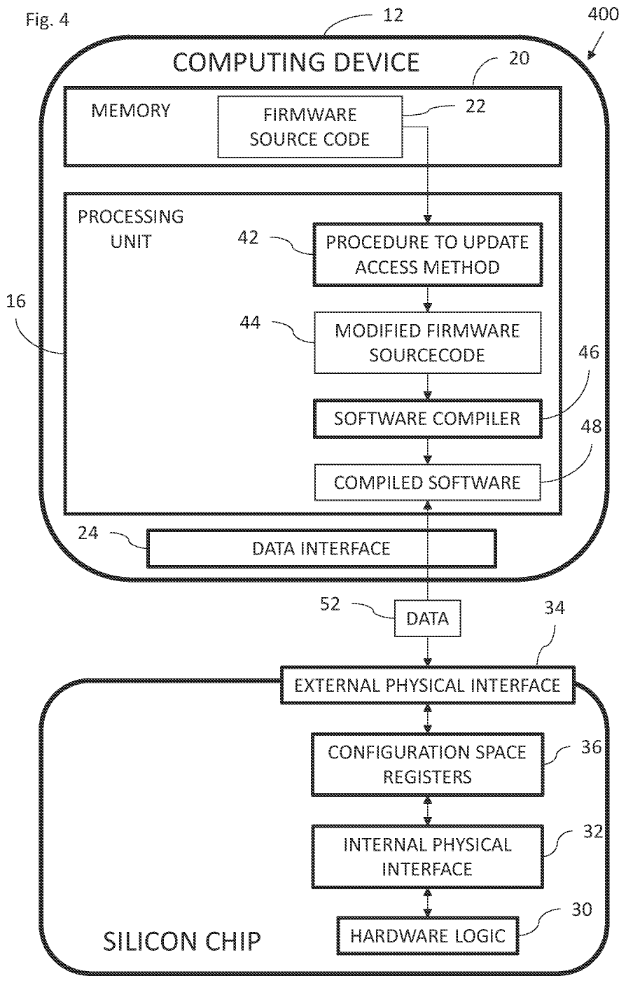

Reference is now made to FIG. 4, which is a block diagram view of a firmware development system 400 constructed and operative in accordance with an alternative embodiment of the present invention. The system 400 is substantially the same as system 10 except that the silicon chip 14 does not include the embedded firmware processor 26 or the internal memory 28. In the system 400, the “firmware” may be executed externally to the silicon chip 14 by executing the compiled software 48 on the processing unit 16. Therefore, the processing unit 16 is configured to execute the compiled software 48 to cause the data interface 24 to read from, and write to, configuration space registers 36 of silicon chip 14 (which does not have an embedded firmware processor), via external physical interface 34 of the silicon chip 14.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A system, comprising a computing device, including:
a data interface to connect to and share data with configuration space registers of a silicon chip via an external physical interface of the silicon chip; and
a processing unit to:
execute a procedure to update parts of firmware source code configured to access the configuration space registers from a firmware processor embedded on the silicon chip via an internal physical interface of the silicon chip to access the configuration space registers via the data interface and via the external physical interface of the silicon chip, yielding modified firmware source code; and
execute a software compiler to compile the modified firmware source code yielding compiled software.

2. The system according to claim 1, wherein the processing unit is to execute the compiled software to cause the data interface to read from, and write to, the configuration space registers of the silicon chip via the external physical interface of the silicon chip.

3. The system according to claim 2, wherein the processing unit is to execute the compiled software to perform computations based on the configuration space registers.

4. The system according to claim 3, further comprising the silicon chip, which includes:
hardware logic to operate based on data stored in the configuration space registers; and
the embedded firmware processor.

5. The system according to claim 4, wherein:
the processing unit is to execute a firmware compiler to compile the firmware source code to yield compiled firmware; and
the embedded firmware processor of the silicon chip is to execute the compiled firmware.

6. The system according to claim 5, wherein:
the processing unit is to write the compiled firmware on a memory; and
the embedded firmware processor is to load the compiled firmware from the memory.

7. The system according to claim 5, wherein the compiled firmware is to:
cause the embedded firmware processor to read from, and write to, the configuration space registers of the silicon chip via the internal physical interface of the silicon chip; and
cause the embedded firmware processor to perform computations based on data stored in the configuration space registers.

8. The system according to claim 2, wherein the processing unit is to:
execute the procedure to update parts of a new version of the firmware source code configured to access the configuration space registers from the embedded firmware processor via the internal physical interface to access the configuration space registers via the data interface and via the external physical interface of the silicon chip, yielding a modified version of the new version of the firmware source code;
execute the software compiler to compile the modified version of the new version of the firmware source code yielding newly compiled software; and
execute the newly compiled software to cause the data interface to read from, and write to, the configuration space registers of the silicon chip via the external physical interface of the silicon chip.

9. The system according to claim 8, wherein the processing unit is to:
run at least one debug method of the compiled software; and
receive a correction to the firmware source code yielding the new version of the firmware source code.

10. The system according to claim 1, wherein the processing unit is to execute the compiled software to cause the data interface to read from, and write to, other configuration space registers of another silicon chip, which does not have an embedded firmware processor, via an external physical interface of the other silicon chip.

11. A computing method, comprising:
connecting to and sharing data with configuration space registers of a silicon chip via an external physical interface of the silicon chip;
executing a procedure to update parts of firmware source code configured to access the configuration space registers from a firmware processor embedded on the silicon chip via an internal physical interface of the silicon chip to access the configuration space registers via the external physical interface of the silicon chip, yielding modified firmware source code; and
executing a software compiler to compile the modified firmware source code yielding compiled software.

12. The method according to claim 11, further comprising executing the compiled software to cause a data interface to read from, and write to, the configuration space registers of the silicon chip via the external physical interface of the silicon chip.

13. The method according to claim 12, further comprising executing the compiled software to perform computations based on the configuration space registers.

14. The method according to claim 13, further comprising hardware logic of the silicon chip operating based on data stored in the configuration space registers.

15. The method according to claim 14, further comprising:
executing a firmware compiler to compile the firmware source code to yield compiled firmware; and
executing the compiled firmware by the embedded firmware processor of the silicon chip.

16. The method according to claim 15, further comprising:
writing the compiled firmware on a memory; and
loading the compiled firmware from the memory by the embedded firmware processor.

17. The method according to claim 15, further comprising:
the compiled firmware causing the embedded firmware processor to read from, and write to, the configuration space registers of the silicon chip via the internal physical interface of the silicon chip; and
the compiled firmware causing the embedded firmware processor to perform computations based on data stored in the configuration space registers.

18. The method according to claim 12, further comprising:
executing the procedure to update parts of a new version of the firmware source code configured to access the configuration space registers from the embedded firmware processor via the internal physical interface to access the configuration space registers via external physical interface of the silicon chip, yielding a modified version of the new version of the firmware source code;
executing the software compiler to compile the modified version of the new version of the firmware source code yielding newly compiled software; and
executing the newly compiled software to cause the data interface to read from, and write to, the configuration space registers of the silicon chip via the external physical interface of the silicon chip.

19. The method according to claim 18, further comprising:
running at least one debug method of the compiled software; and
receiving a correction to the firmware source code yielding the new version of the firmware source code.

20. The method according to claim 11, further comprising executing the compiled software to cause a data interface to read from, and write to, other configuration space registers of another silicon chip, which does not have an embedded firmware processor, via an external physical interface of the other silicon chip.
